(19) United States
(12) Patent Application Publication
(10) Pub. No.: US 2016/0116770 A1
(43) Pub. Date: Apr. 28, 2016

(54) LIQUID CRYSTAL DISPLAY APPARATUS

(71) Applicant: SHARP KABUSHIKI KAISHA, Osaka (JP)

(72) Inventors: Tetsuo FUKAYA, Osaka-shi (JP); Masahiro SHIMIZU, Osaka-shi (JP); Taichi SASAKI, Osaka-shi (JP); Masatoshi KONDO, Osaka-shi (JP)

(21) Appl. No.: 14/896,750

(22) PCT Filed: Feb. 21, 2014
(86) PCT No.: PCT/JP2014/054192

§ 371 Date: Dec. 8, 2015

(30) Foreign Application Priority Data
Jun. 28, 2013 (JP) 2013-136079

(51) Int. Cl. G02F 1/1337; G02F 1/1343; G02F 1/1335

(52) U.S. Cl. CPC G02F 1/1337; G02F 1/133512; G02F 1/134309; G02F 2001/133738; G02F 2001/133749; G02F 2001/134372

(57) ABSTRACT

In a liquid crystal display device (100), a first substrate (10) includes a first alignment film (25), a first electrode (24), a dielectric layer (23), and a second electrode (22), in this order away from a liquid crystal layer. One of the first and second electrode includes a plurality of linear portions (24s) which are parallel to each other. The second substrate (30) includes a second alignment film (35) and a light shielding layer (32) in this order away from the liquid crystal layer, the light shielding layer (32) having an opening (32a). The liquid crystal layer (42) contains a nematic liquid crystal material having negative dielectric anisotropy. Liquid crystal molecules contained in the liquid crystal material are aligned essentially horizontally by the first and second alignment films. The opening (32a) of the light shielding layer (32) has two sides which run parallel to the plurality of linear portions (24s) and define the width of the opening. Given distances D1 and D2 from the two sides of the opening (32a) to the closest ones of the plurality of linear portions (24s), (D1+D2)/2 is equal to or greater than 1.0 μm but less than 3.0 μm.

### TECHNICAL FIELD

The present invention relates to a liquid crystal display device, and more particularly to a liquid crystal display device of the Fringe Field Switching (FFS) mode.

### BACKGROUND ART

Liquid crystal display devices of the FFS mode have an advantage in that their y characteristics are less dependent on the viewing angle, as compared to liquid crystal display devices of conventional vertical field modes (e.g., VA mode), and are increasingly more used as medium- or small-sized liquid crystal display devices. However, further improvements in display quality are being desired, and an improved display luminance (transmittance) is especially expected of FFS mode liquid crystal display devices.

In FFS mode liquid crystal display devices that are currently commercially-available, nematic liquid crystal materials which are P-type liquid crystal materials (having a positive dielectric anisotropy, Δ∈>0) are used. On the other hand, Patent Document 1 states that use of a nematic liquid crystal material which is an N-type liquid crystal material (having negative dielectric anisotropy, Δ∈<0) provides an improved display luminance.

### CITATION LIST

### Patent Literature

[Patent Document 1] Japanese Laid-Open Patent Publication No. 2010-8597

### SUMMARY OF INVENTION

### Technical Problem

While Patent Document 1 discloses an FFS mode liquid crystal display device in which an N-type liquid crystal material is used, it fails to describe any relationship between a specific pixel structure and display luminance.

An objective of the present invention is to effectively enhance the display luminance of an FFS mode display device in which an N-type liquid crystal material is used.

### Solution to Problem

A liquid crystal display device according to an embodiment of the present invention comprises: a first substrate, a second substrate, and a liquid crystal layer interposed between the first substrate and the second substrate, the first substrate including a first alignment film, a first electrode, a dielectric layer, a second electrode in this order away from the liquid crystal layer, one of the first and second electrodes having a plurality of linear portions which are parallel to each other, the second substrate including a second alignment film and a light shielding layer in this order away from the liquid crystal layer, the light shielding layer having an opening, the liquid crystal layer containing a nematic liquid crystal material having negative dielectric anisotropy, liquid crystal molecules contained in the liquid crystal material being aligned essentially horizontally by the first and second alignment films, wherein, the opening of the light shielding layer has two sides which run parallel to the plurality of linear portions and define a width of the opening; and given distances D1 and D2 from the two sides of the opening to closest ones of the plurality of linear portions, (D1+D2)/2 is equal to or greater than 1.0 μm but less than 3.0 μm. The alignment directions as regulated by the first and second alignment films are parallel or antiparallel.

In one embodiment, the first and second alignment films are photo-alignment films. A preferable photo-alignment film defines its regulated alignment direction through photoisomerization.

In one embodiment, regulated alignment directions as regulated by the first and second alignment films are essentially orthogonal to the plurality of linear portions.

In one embodiment, pretilt angles which are defined by the first and second alignment films are 0°.

In one embodiment, each of the plurality of linear portions has a width L of not less than 1.5 μm and not more than 3.5 μm, and an interspace between two adjacent linear portions has a width S which is greater than 3.0 μm but not more than 6.0 μm.

In one embodiment, the first electrode includes the plurality of linear portions. In one embodiment, the second electrode includes the plurality of linear portions. The electrode that includes the plurality of linear portions is a pixel electrode or a counter electrode (common electrode).

### Advantageous Effects of Invention

According to an embodiment of the present invention, the display luminance of an FFS mode display device in which an N-type liquid crystal material is used can be effectively enhanced.

### BRIEF DESCRIPTION OF DRAWINGS

FIG. 1 (a) is a schematic plan view of a liquid crystal display device 100; and (b) is a schematic cross-sectional view taken along line 1B-1B′ in (a).

FIG. 2 A graph showing how a mode efficiency may depend on D in the case where an N-type liquid crystal material is used and in the case where a P-type liquid crystal material is used.

FIG. 3 A graph showing a transmittance distribution in a pixel of the liquid crystal display device 100.

FIG. 4 (a) is a diagram schematically showing an alignment of liquid crystal molecules of a P-type liquid crystal material; and (b) is a diagram schematically showing an alignment of liquid crystal molecules of an N-type liquid crystal material.

FIG. 5 A graph showing polar angle dependence of the light leakage ratio in the case where a negative type liquid crystal material is used.

### DESCRIPTION OF EMBODIMENTS

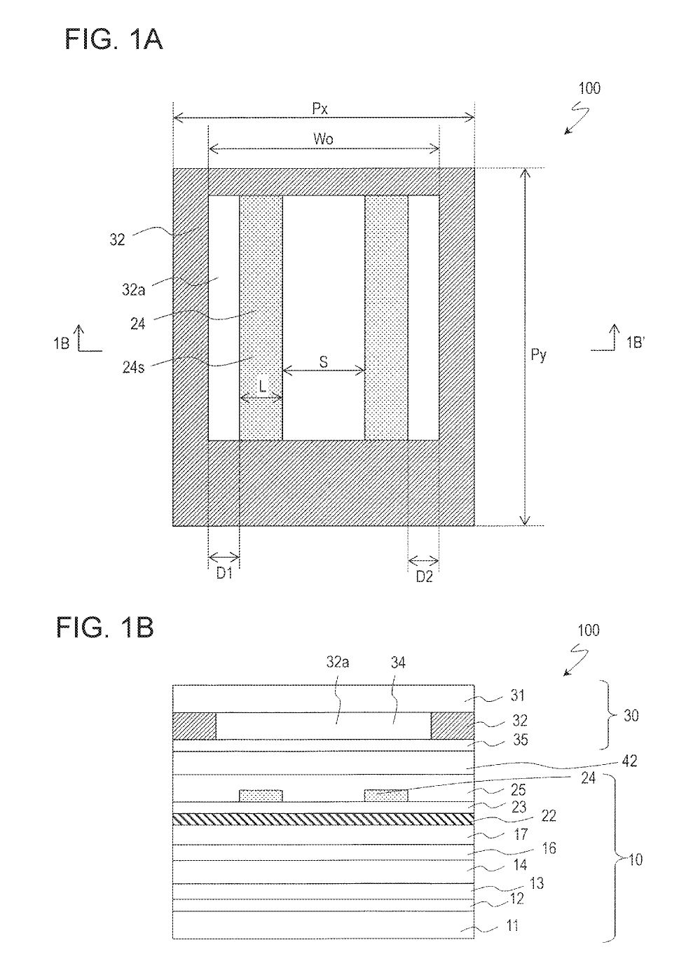

Hereinafter, with reference to the drawings, the structure of a liquid crystal display device 100 according to an embodiment of the present invention will be described. FIGS. 1(a) and (b) schematically show the structure of the liquid crystal display device 100 according to the embodiment of the present invention. FIG. 1(a) is a schematic plan view of the liquid crystal display device 100, and FIG. 1(b) is a schematic cross-sectional view taken along line 1B-1B′ in FIG. 1(a). FIGS. 1(a) and (b) show structure corresponding to one pixel of the liquid crystal display device 100. The liquid crystal display device has a plurality of pixels arranged in a matrix array of rows and columns, where the pixels are arranged with a pitch Px along the row direction and with a pitch Py along the column direction.

The liquid crystal display device 100 includes a TFT substrate (first substrate) 10, a counter substrate (second substrate) 30, and a liquid crystal layer 42 provided between the TFT substrate 10 and the counter substrate 30. The liquid crystal display device 100 further includes a pair of polarizers not shown. The polarizers are placed in crossed Nicols on the outside of the TFT substrate 10 and the counter substrate 30. The transmission axis (polarization axis) of one of them is oriented in the horizontal direction, whereas the transmission axis of the other is oriented in the vertical direction.

The TFT substrate 10 includes a first alignment film 25, a first electrode 24, a dielectric layer 23, and a second electrode 22, in this order away from the liquid crystal layer 42. The first electrode 24 includes a plurality of linear portions 24s that are parallel to one another. Although a structure is illustrated herein where the first electrode 24 includes the plurality of linear portions 24s, it may be the second electrode that includes a plurality of linear portions. The linear portions 24s can be formed by making slits in an electrically conductive film that composes the first electrode 24, for example. One of the first electrode 24 and the second electrode 22 is a pixel electrode and the other is a counter electrode (common electrode); herein, an example will be illustrated where the first electrode 24 is a pixel electrode and the second electrode 22 is a counter electrode. In this exemplary case, the counter electrode is typically a spread electrode (a film electrode without slits or the like). The width L of each of the plurality of linear portions 24s of the pixel electrode 24 is e.g. not less than 1.5 μm and not more than 3.5 μm, and the interspace between two adjacent linear portions 24s has a width S of e.g. greater than 3.0 μm but not more than 6.0 μm. The pixel electrode 24 and the counter electrode 22 are made of a transparent electrically conductive material such as ITO.

The liquid crystal display device 100 is a TFT type, where the pixel electrode 24 is connected to a drain electrode of a TFT such that a display signal is supplied via the TFT from a source bus line (not shown) which is connected to a source electrode of the TFT. Source bus lines are disposed so as to extend along the column direction, whereas gate bus lines are disposed so as to extend along the row direction. Preferable TFTs are those made of an oxide semiconductor. Oxide semiconductors, such as In—Ga—Zn—O-type semiconductors, have a high mobility, and therefore can be downsized to achieve a higher pixel aperture ratio. The oxide semiconductors to be suitably used for the liquid crystal display device 100 will be described later. Various FFS mode liquid crystal display devices including TFTs which are made of an oxide semiconductor are known, as is disclosed in International Publication No. 2013/073635, for example. The entire disclosure of International Publication No. 2013/073635 is incorporated herein by reference. FIG. 1(b) schematically shows the multilayer structure in the case of adopting bottom-gate type TFTs.

The TFT substrate 10 further includes a substrate (e.g. a glass substrate) 11, a gate metal layer 12 formed thereon, a gate insulating layer 13 covering the gate metal layer 12, an oxide semiconductor layer 14 formed on the gate insulating layer 13, a source layer 16 formed on the oxide semiconductor layer 14, and an interlevel insulating layer 17 formed on the source layer 16. Although illustration is simplified herein, the gate metal layer 12 includes a gate electrode, a gate bus line, and an interconnect for the counter electrode; the oxide semiconductor layer 14 includes a TFT active layer; and the source layer 16 includes a source electrode, a drain electrode, and a source bus line. The counter electrode 22 is formed on the interlevel insulating layer 17. As necessary, a planarization layer may be further provided between the interlevel insulating layer 17 and the counter electrode 22.

The counter substrate 30 includes a second alignment film 35 and a light shielding layer 32 (black matrix) on the substrate (e.g., a glass substrate) 31, in this order away from the liquid crystal layer 42, the light shielding layer 32 having an opening 32a. A color filter layer 34 is formed in the opening 32a of the light shielding layer 32. The light shielding layer 32 can be formed by using a black resin layer which is photosensitive, for example. Also, the color filter layer 34 can be formed by using a colored resin layer which is photosensitive. On the outside of the substrate 31 (i.e., on the opposite side from the liquid crystal layer 42), a transparent electrically conductive layer (not shown) for antistatic purposes, which is made of ITO or the like, may be provided as necessary.

The liquid crystal layer contains a nematic liquid crystal material having negative dielectric anisotropy, such that the liquid crystal molecules contained in the liquid crystal material are aligned essentially horizontally owing to the first alignment film 25 and the second alignment film 35. The alignment directions as regulated by the first alignment film 25 and the second alignment film 35 may be parallel or antiparallel. The alignment directions as regulated by the first alignment film and the second alignment film are essentially orthogonal to the direction that the linear portions 24s extend. The pretilt angles which are defined by the first alignment film 25 and the second alignment film 35 may be 0°, for example.

The first alignment film 25 and the second alignment film 35 are photo-alignment films, for example. Preferable photo-alignment films are those which define their regulated alignment directions through photoisomerization. As the photo-alignment films, photo-alignment films described in International Publication No. 2009/157207 can be used. For example, a photo-alignment film can be formed by irradiating with polarized ultraviolet rays an alignment film being made of a polymer which is composed of a main chain of polyimide and a side chain containing a cinnamate group as a photoreactive functional group. The entire disclosure of International Publication No. 2009/157207 is incorporated herein by reference.

The opening 32a of the light shielding layer 32 of the liquid crystal display device 100 has two sides which run parallel to the plurality of linear portions 24s and define the width Wo of the opening 32a. Given distances D1 and D2 from the two sides of the opening 32a to the closest ones of the plurality of linear portions 24s, (D1+D2)/2 is equal to or greater than 1.0 μm but less than 3.0 μm. (D1+D2)/2 may be denoted as D. When there is no misalignment between the TFT substrate and the counter substrate 30, it follows that D1=D2=D. Since the opening 32a and the linear portions 24s of the pixel electrode 24 are disposed so as to satisfy the aforementioned relationship, the liquid crystal display device 100 is able to effectively enhance display luminance. This will be described in detail below.

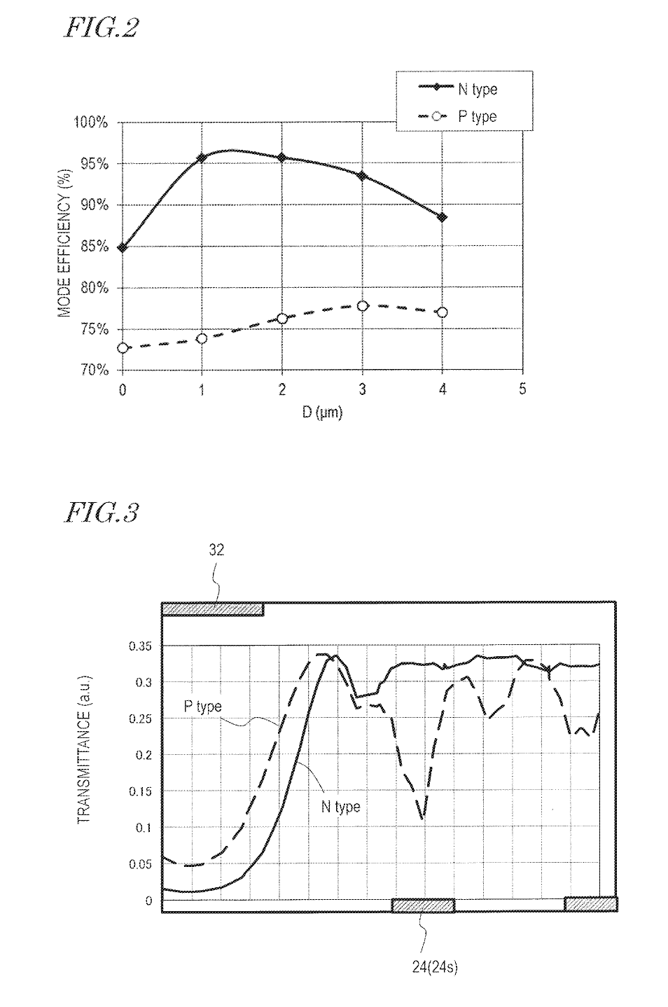

FIG. 2 shows how a mode efficiency may depend on D in the case where an N-type liquid crystal material is used and in the case where a P-type liquid crystal material is used. The mode efficiency is defined as follows. The higher the mode efficiency is, the higher the display luminance is.

mode efficiency (%)=((light transmittance of liquid crystal display panel)/(light transmittance of an imaginary case where only a pair of polarizers are disposed in parallel Nicols))*100

In the above equation, the “light transmittance of liquid crystal display panel” is normalized based on the aperture ratio. In the above equation, represents multiplication. The aperture ratio represents a ratio of the geometric area that contributes to actual displaying, to the geometric area of the displaying region of the liquid crystal display panel. With reference to FIG. 1(a), this corresponds to a ratio of the geometric area of the opening 32a to the geometric area which is represented by a product of Px and Py.

Now, the construction (see FIG. 1) used for the simulation is shown below. Expert LCD (manufactured by DAOU XILICON Co., Ltd.) was used in the simulation.

Px=27 μm,Py=81 μm,Wo=19 μm,L/S=2.6 μm/3.8 μm

N-type liquid crystal material: Δ∈=−4.2; Δn=0.103; white displaying voltage 5.0V; liquid crystal layer thickness 3.4 μm

P-type liquid crystal material: Δ∈=7.8; Δn=0.103; white displaying voltage 4.6V; liquid crystal layer thickness 3.4 μm

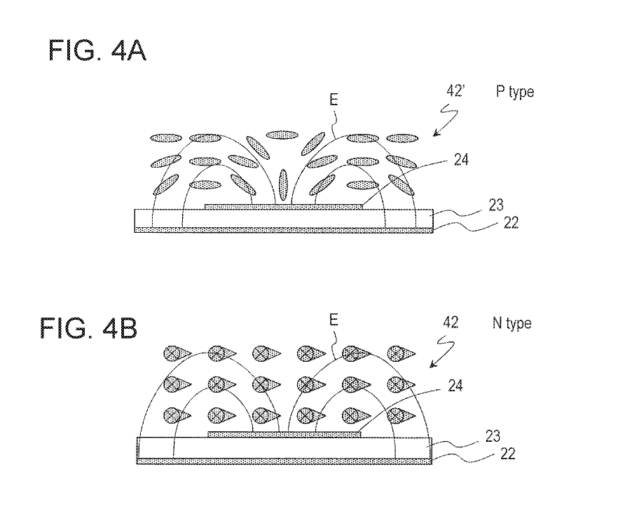

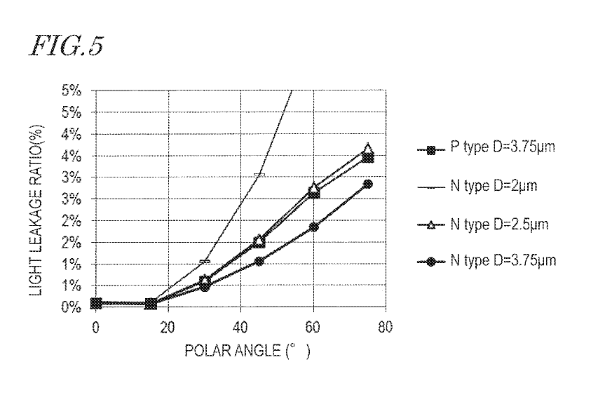

As will be readily seen from FIG. 2, the mode efficiency is higher when an N-type liquid crystal material is used than when a conventional P-type mode liquid crystal is used. This is because, as is also described in Patent Document 1, there is a difference in the manner in which the liquid crystal molecules undergo changes in their alignment, depending on a P-type liquid crystal material or an N-type liquid crystal material; this will be described later with reference to FIG. 4.

What is surprising in FIG. 2 is that the relationship between the mode efficiency and the distances D from the sides of the opening 32a of the light shielding layer 32 to the linear portions 24s of the pixel electrode 24 differs between the N-type liquid crystal material and the P-type liquid crystal material. In a conventional liquid crystal display device in which a P-type liquid crystal material is used, the mode efficiency is largest when D is near 3 μm. On the other hand, when an N-type liquid crystal material is used, the mode efficiency is largest when D is between 1 μm and 2 μm, and the mode efficiency is about 4% lower than its maximum value when D is 3 μm.

Thus it can be seen that, in a liquid crystal display device 100 in which an N-type liquid crystal material is used, the mode efficiency (i.e., display luminance) can be effectively enhanced by ensuring that D is equal to or greater than 1 μm but less than 3 μm.

This phenomenon will be described with reference to FIG. 3 and FIG. 4.

FIG. 3 is a graph showing a transmittance distribution in a pixel of the liquid crystal display device 100. These are simulation results in the absence of the light shielding layer 32. The transmittance values are in arbitrary units (a.u.).

As can be seen from FIG. 3, when a P-type liquid crystal material is used, transmittance is reduced above the linear portions 24s of the pixel electrode 24, thus resulting in fluctuating transmittances along the cross-sectional direction. On the other hand, when an N-type liquid crystal material is used, decrease of transmittance is not observed above the linear portions 24s of the pixel electrode 24, and fluctuations of transmittance along the cross-sectional direction are small. This is because, as shown in FIGS. 4(a) and (b), there is a difference in the manner in which the liquid crystal molecules undergo changes in their alignment, depending on a P-type liquid crystal material or an N-type liquid crystal material.

As shown in FIG. 4(a), when an electric field from the pixel electrode 24 and the counter electrode 22 acts on the liquid crystal layer 42′ composed of a P-type liquid crystal material, the P-type liquid crystal molecules will be aligned so that the major axis (i.e., the axis associated with a large dielectric constant) of each molecule is parallel to the electric lines of force. Therefore, as schematically shown in FIG. 4(a), some liquid crystal molecules rise from the substrate plane (i.e., the plane of the liquid crystal layer). When a liquid crystal molecule rises, the retardation of that portion becomes smaller than the retardation in any other portion, thus resulting in a correspondingly lower transmittance.

As shown in FIG. 4(b), when an electric field from the pixel electrode 24 and the counter electrode 22 acts on a liquid crystal layer 42 composed of an N-type liquid crystal material, the N-type liquid crystal molecules will be aligned so that the major axis (i.e., the axis associated with a large dielectric constant) of each molecule is orthogonal to the electric lines of force. Even if the voltage that is applied to the liquid crystal layer 42 is changed in magnitude, the N-type liquid crystal molecules will only change their alignment direction within a plane which is parallel to the substrate plane (i.e., the plane of the liquid crystal layer), rather than some liquid crystal molecules rising from the substrate plane (i.e., the plane of the liquid crystal layer); thus, the transmittance will not be reduced as in the case of a P-type liquid crystal material.

Next, look at the left side of FIG. 3. Transmittance once increases away from the edge of the pixel electrode 24, and then decreases. The decrease in transmittance begins closer to the edge of the pixel electrode 24 in an N-type liquid crystal material than in a P-type liquid crystal material. Moreover, this decreasing tendency of transmittance is steeper in an N-type liquid crystal material than in a P-type liquid crystal material. That is, when an N-type liquid crystal material is used, the region from the edge of the pixel electrode 24 to the edge of the opening in the light shielding layer 32 has less contribution to displaying than in the case of using a P-type liquid crystal material. Thus, as shown in FIG. 2, in the case of using an N-type liquid crystal material, the mode efficiency can be further enhanced by making D smaller than in the case of using a P-type liquid crystal material.

When the liquid crystal display device 100 is observed obliquely, the colors of two adjacent pixels are intermixed (e.g., red and blue). This phenomenon may be referred to as a color washout. In order to prevent a color washout, D is set to 3.75 μm in a conventional display device in which a P-type liquid crystal material is used. As has been described with reference to FIG. 2, the mode efficiency becomes largest when D is near 3.0 μm in a display device in which a P-type liquid crystal material is used; however, D is made 0.75 μm larger therefrom in order to prevent a color washout.

Now, the problem of intermixing of colors in a color liquid crystal display device will be described. In a color liquid crystal display device, a number of pixels constitute one multicolor displaying pixel. Typically, three primary-color pixels (which are simply referred to as pixels) of a red pixel, a green pixel, and a blue pixel constitute one multicolor displaying pixel. In a color liquid crystal display device of a typical stripe arrangement, pixels of different colors are arranged along the row direction; therefore, when the viewing angle is inclined in the horizontal direction from the normal direction of the display plane, intermixing of colors occurs. The degree of intermixing of colors can be quantitated by using a light leakage ratio that is defined as follows. When one of two adjacent pixels along the row direction is placed in a white displaying state (i.e., lit) and the other pixel assumes the transmittance of a black displaying state (i.e., unlit), a light leakage ratio is defined as a ratio of the transmittance of the unlit pixel to the transmittance of the lit pixel. That is, the light leakage ratio is defined by the following equation.

light leakage ratio (%)=((transmittance of unlit pixel)/(transmittance of lit pixel))×100

Herein, with respect to the same construction for which the mode efficiency was determined as per FIG. 2, light leakage ratios at various viewing angles (expressed in polar angles from the surface normal) were determined in a simulation using Expert LCD.

FIG. 5 shows polar angle dependence of the light leakage ratio in the case where a negative type liquid crystal material is used. The horizontal axis represents the polar angle, which indicates a magnitude of inclination from the display plane normal, whereas the vertical axis represents the light leakage ratio (%). For comparison's sake, the polar angle dependence of the light leakage ratio of a conventional display device in which a P-type liquid crystal material is used is also shown, in which D is 3.75 μm.

As seen from FIG. 5, by increasing D, the light leakage ratio at oblique viewing angles can be decreased. Currently, in order to obtain a light leakage ratio similar to those of display devices in which a P-type liquid crystal material is used, which enjoy market popularity, it may be ensured in a display device in which an N-type liquid crystal material is used that D is 2.5 μm or more. Therefore, in order to obtain a high mode efficiency and also prevent a color washout, it is preferable that D is equal to or greater than 2.5 μm but less than 3.0 μm.

It will be appreciated that display luminance may be favored over color washout prevention, which may not even be necessary depending on the manner in which the liquid crystal display device is used.

As described above, it is preferable to use TFTs having an oxide semiconductor layer, as the TFTs of the liquid crystal display device 100 according to an embodiment of the present invention. Preferable oxide semiconductors are semiconductors of the In—Ga—Zn—O-type (hereinafter abbreviated as “In—Ga—Zn—O-type semiconductors”), among which In—Ga—Zn—O-type semiconductors including a crystalline portion are more preferable. Herein, an In—Ga—Zn—O-type semiconductor is a ternary oxide of In (indium), Ga (gallium), and Zn (zinc), with no particular limitation as to the proportions of In, Ga, and Zn (composition ratio); for example, In:Ga:Zn=2:2:1, In:Ga:Zn=1:1:1, In:Ga:Zn=1:1:2, etc., are included.

A TFT that includes an In—Ga—Zn—O-type semiconductor layer has a high mobility (more than 20 times that of an a-Si TFT) and a low leak current (less than 1/100 of that of an a-Si TFT), and therefore is suitably used not only as a pixel TFT but also as a driving TFT. When a TFT that includes an In—Ga—Zn—O-type semiconductor layer is used, the effective aperture ratio of the display device can be increased, and also the power consumption of the display device can be reduced.

In—Ga—Zn—O-type semiconductors may be amorphous, or may include a crystalline portion and be crystalline. As a crystalline In—Ga—Zn—O-type semiconductor, a crystalline In—Ga—Zn—O-type semiconductor whose c axis is oriented substantially perpendicular to the layer plane is preferable. The crystal structure of such an In—Ga—Zn—O-type semiconductor is disclosed in, for example, Japanese Laid-Open Patent Publication No. 2012-134475. The entire disclosure of Japanese Laid-Open Patent Publication No. 2012-134475 is incorporated herein by reference.

Instead of an In—Ga—Zn—O-type semiconductor, the oxide semiconductor layer may contain another oxide semiconductor. For example, it may contain a Zn—O-type semiconductor (ZnO), an In—Zn—O-type semiconductor (IZO(registered trademark)), a Zn—Ti—O-type semiconductor (ZTO), a Cd—Ge—O-type semiconductor, a Cd—Pb—O-type semiconductor, CdO (cadmium oxide), an Mg—Zn—O-type semiconductor, an In—Sn—Zn—O-type semiconductor (e.g., In₂O₃—SnO₂—ZnO), an In—Ga—Sn—O-type semiconductor, or the like.

### INDUSTRIAL APPLICABILITY

According to the present invention, the display luminance of an FFS mode display device can be effectively enhanced.

### REFERENCE SIGNS LIST

10 TFT substrate (first substrate)
11 substrate
12 gate metal layer
13 gate insulating layer
14 oxide semiconductor layer
16 source layer
17 interlevel insulating layer
22 counter electrode (second electrode)
23 dielectric layer
24 pixel electrode (first electrode)
24s linear portion
25 first alignment film
30 counter substrate (second substrate)
31 substrate
32 light shielding layer
32a opening
34 color filter
35 second alignment film
42 liquid crystal layer
100 liquid crystal display device

1. A liquid crystal display device comprising:
a first substrate, a second substrate, and a liquid crystal layer interposed between the first substrate and the second substrate,
the first substrate including a first alignment film, a first electrode, a dielectric layer, a second electrode in this order away from the liquid crystal layer, one of the first and second electrodes having a plurality of linear portions which are parallel to each other,
the second substrate including a second alignment film and a light shielding layer in this order away from the liquid crystal layer, the light shielding layer having an opening,
the liquid crystal layer containing a nematic liquid crystal material having negative dielectric anisotropy, liquid crystal molecules contained in the liquid crystal material being aligned essentially horizontally by the first and second alignment films, wherein,
the opening of the light shielding layer has two sides which run parallel to the plurality of linear portions and define a width of the opening; and
given distances D1 and D2 from the two sides of the opening to closest ones of the plurality of linear portions, (D1+D2)/2 is equal to or greater than 1.0 μm but less than 3.0 μm.

2. The liquid crystal display device of claim 1, wherein the first and second alignment films are photo-alignment films.

3. The liquid crystal display device of claim 1, wherein defined alignment directions which are defined by the first and second alignment films are essentially orthogonal to the plurality of linear portions.

4. The liquid crystal display device of any of claim 1, wherein pretilt angles which are defined by the first and second alignment films are 0°.

5. The liquid crystal display device of claim 1, wherein each of the plurality of linear portions has a width L of not less than 1.5 μm and not more than 3.5 μm, and an interspace between two adjacent linear portions has a width S which is greater than 3.0 μm but not more than 6.0 μm.

6. The liquid crystal display device of claim 1, wherein the first electrode includes the plurality of linear portions.
